(19) United States
(12) Patent Application Publication
(10) Pub. No.: US 2017/0050648 A1
(43) Pub. Date: Feb. 23, 2017

(54) MOUNT ASSEMBLY

(71) Applicant: Electro-Motive Diesel, Inc., LaGrange, IL (US)

(72) Inventor: Andrew P. Quinn, Leonay (AU)

(73) Assignee: Electro-Motive Diesel, Inc., LaGrange, IL (US)

(21) Appl. No.: 14/828,741

(22) Filed: Aug. 18, 2015

(51) Int. Cl. B61C 17/04; B61F 1/14; F16M 5/00

(52) U.S. Cl. CPC B61C 17/04; F16M 5/00; B61F 1/14

(57) ABSTRACT

A mount assembly for a machine having a cab mounted on an underframe. The mount assembly includes a first member coupled to the underframe. The mount assembly includes a second member coupled to the cab and at least partly received within the first member. The second member includes an extension projecting from the first member. The mount assembly further includes an isolation member disposed between the first member and the second member. The mount assembly includes a pair of snubber members coupled to the extension of the second member. Each of the pair of snubber member is spaced apart from the first member.

### TECHNICAL FIELD

The present disclosure relates to a mount assembly for a machine, and more particularly to the mount assembly provided between a cab and an underframe of the machine.

### BACKGROUND

A machine, such as a locomotive, is subjected to significant structure borne noise and vibrations. During machine operation, the noise and vibrations are transferred to an operator cab of the machine. The noise and vibrations may cause discomfort to an operator seated within the operator cab. In order to isolate the operator cab of the machine, the operator cab structure is often mounted on rubber blocks called resilient mounts. One common arrangement has mounts that are V-shaped with a pair of inclined rubber pads associated therewith. The existing mounts have a snubber plate that is bolted up underneath the mount to prevent the mount from separating when placed under tension. The snubber plate is attached to a surface of the mount by a pair of bolts.

In operation, the operator cab withstands significant loads to provide collision and rollover protection for the operator seated within the operator cab. These loads can cause the mounts to fail and the operator cab to disconnect from the underframe. Due to the V-shape of the mounts, it may be difficult to produce a mount having a snubber plate of sufficient strength to withstand heavy loads during machine operation.

U.S. Pat. No. 3,834,320 describes a sprung wear plate particularly useful for reliable secure application to the side frame columns of a railway truck is made from a single metal strip having a concave surface facing the flat mounting surface on the side frame column. The plate has holes for attachment by bolts through aligned holes in the column. High strength bolts are used such that tightening of the bolts flattens out the concave surface of plate into full contact with the column locking the bolts therein. The bolts preferably have tapered heads received in tapered holes in the plates to prevent accidental application of the plates with the concave surface facing outwardly.

### SUMMARY OF THE DISCLOSURE

In one aspect of the present disclosure, a mount assembly for a machine is provided. The machine includes a cab mounted on an underframe. The mount assembly includes a first member coupled to the underframe. The mount assembly also includes a second member coupled to the cab and at least partly received within the first member. The second member includes an extension projecting from the first member. The mount assembly further includes an isolation member disposed between the first member and the second member. The mount assembly includes a pair of snubber members coupled to the extension of the second member. Each of the pair of snubber members is spaced apart from the first member.

In another aspect of the present disclosure, a locomotive is provided. The locomotive includes an underframe. The locomotive also includes a cab mounted on the underframe. The locomotive further includes a mount assembly disposed between the cab and the underframe. The mount assembly includes a first member coupled to the underframe. The mount assembly also includes a second member coupled to the cab and at least partly received within the first member. The second member includes an extension projecting from the first member. The mount assembly further includes an isolation member disposed between the first member and the second member. The mount assembly includes at least one snubber member coupled to the extension of the second member. Each of the pair of snubber member is spaced apart from the first member.

In yet another aspect of the present disclosure, a mount assembly for a machine is provided. The machine includes a cab mounted on an underframe. The mount assembly includes a first member coupled to the underframe. The first member includes a lower surface. The mount assembly also includes a second member coupled to the cab and at least partly received within the first member. The second member includes an extension projecting from the first member. The extension includes a first surface and a second surface opposite to the first surface. Each of the first surface and the second surface is spaced apart from the lower surface of the first member. The mount assembly further includes a pair of isolation members disposed between the first member and the second member. The mount assembly includes a pair of snubber members coupled to the extension of the second member. Each of the pair of snubber member is spaced apart from the lower surface of the first member. One of the pair of snubber members is coupled to the first surface, whereas another of the pair of snubber members is coupled to the second surface.

Other features and aspects of this disclosure will be apparent from the following description and the accompanying drawings.

### BRIEF DESCRIPTION OF THE DRAWINGS

FIG. 1 is a perspective view of a portion of an exemplary machine having a cab and an underframe, according to one embodiment of the present disclosure;

FIG. 2 is a partial cut away view of the machine of FIG. 1 showing a mount assembly provided between the cab and the underframe, according to one embodiment of the present disclosure;

FIG. 3 is a perspective view of the mount assembly, according to one embodiment of the present disclosure;

FIG. 4 is a cross sectional view of the mount assembly of FIG. 3, according to one embodiment of the present disclosure; and

FIG. 5 is a perspective view of another mount assembly, according to other embodiments of the present disclosure.

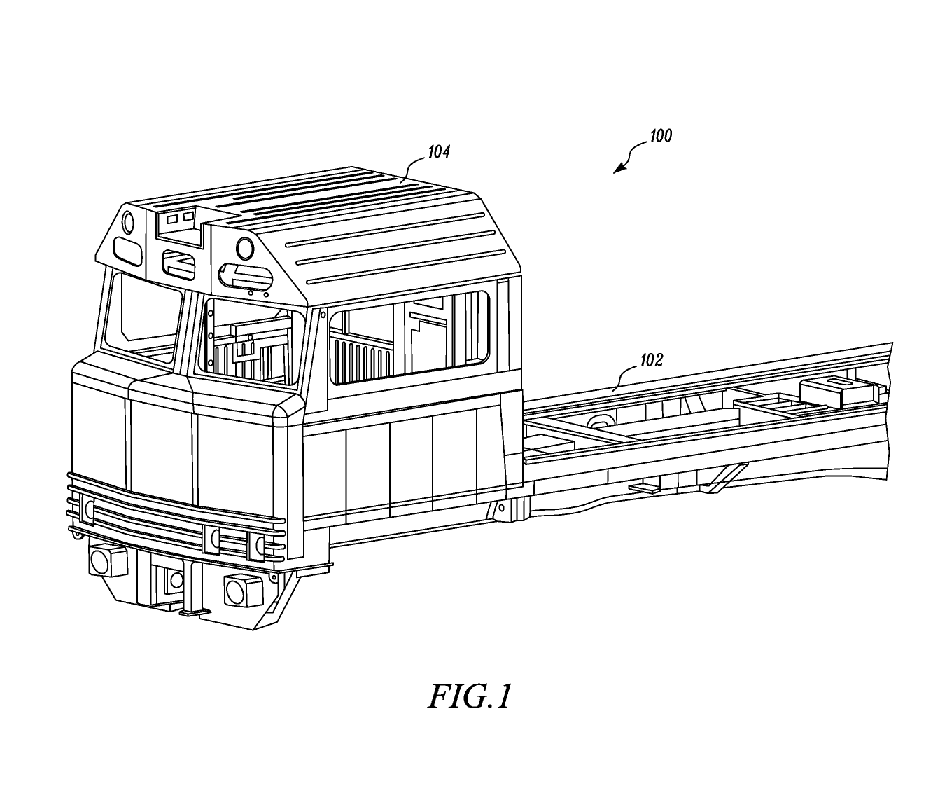

### DETAILED DESCRIPTION

Wherever possible, the same reference numbers will be used throughout the drawings to refer to the same or the like parts. FIG. 1 is a perspective view of a portion of an exemplary machine 100. In the illustrated embodiment, the machine 100 is a locomotive. However, it should be noted that the application of the present disclosure is not restricted to the locomotive. The machine 100 may embody any of an on-highway truck, an off-highway truck, an earth moving machine, and other similar machines.

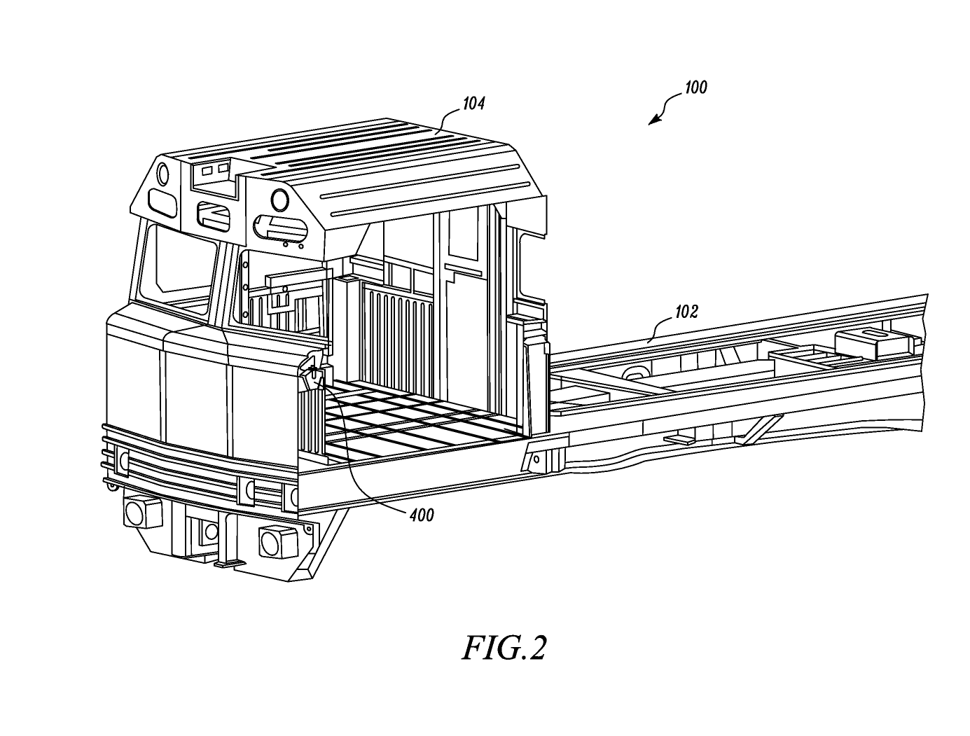

Referring to FIGS. 1 and 2, the machine 100 includes an underframe 102. The underframe 102 houses various components of the machine 100 that assist in the operation of the machine 100. In one example, a power source (not shown) may be mounted on the underframe 102 of the machine 100. The power source may include any one of an internal combustion engine, an electric motor, power storage devices like batteries, a hybrid engine, and the like. The power source is configured to provide power to the machine 100 for operational and mobility requirements. The machine 100 may include a set of ground engaging members (not shown). The ground engaging members may include any one of a tracks or wheels. The ground engaging members are configured to provide mobility to the machine 100.

The machine 100 may also include a drivetrain (not shown) coupled to the power source and the ground engaging members. The drivetrain may include a transmission system having one or more gears, shafts, differentials, torque convertor, hydraulic pump or motor, and so on. The drivetrain may be configured to transmit motive power from the power source to the ground engaging members.

The machine 100 includes an operator cab 104, hereinafter referred to as the cab 104, mounted on the underframe 102 of the machine 100. The cab 104 is coupled with the underframe 102. The cab 104 includes an operator interface (not shown). The operator interface may include one or more input devices such as pedals, steering, joystick, knobs, levers, switches, display devices, and so on. The input device may assist an operator seated within the cab 104 to operate the machine 100.

During operation of the machine 100, the underframe 102 may vibrate due to rotating components present thereon and also due to vibrations transmitted from the ground engaging members during motion of the machine 100. The noise and vibrations may transfer to the cab 104 and may cause discomfort to the operator seated inside the cab 104. In order to isolate the cab 104 from vibrations, a number of mount assemblies 400 are provided between the cab 104 and the underframe 102. FIG. 2 illustrates one such mount assembly 400 disposed between the cab 104 and the underframe 102.

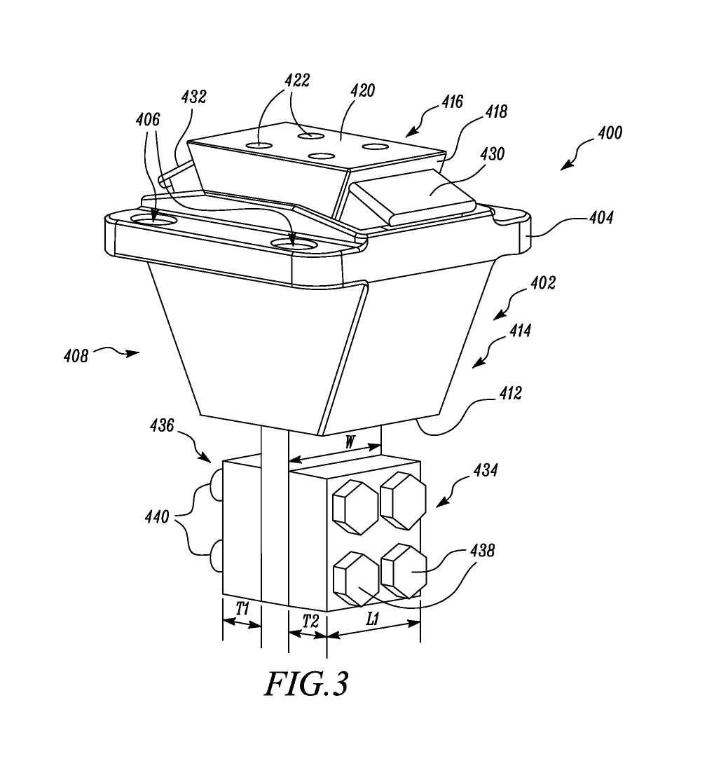

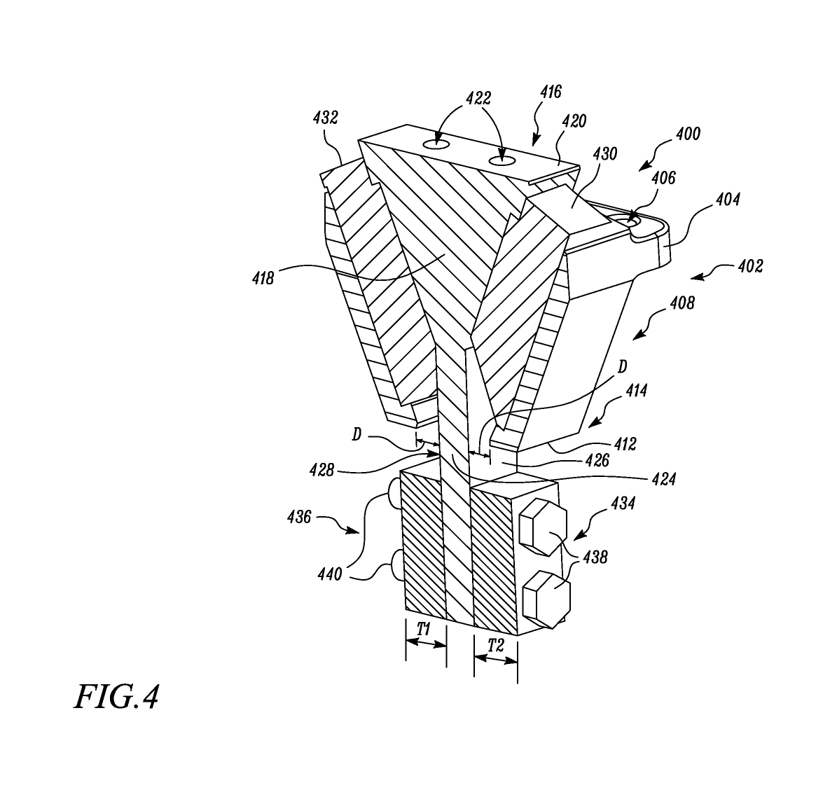

The mount assembly 400 will now be explained in detail with reference to FIGS. 3 and 4. The mount assembly 400 includes a first member 402. The first member 402 has a hollow structure. The first member 402 is coupled to the underframe 102 of the machine 100. The first member 402 includes a flange 404. The flange 404 includes a number of openings 406 provided thereon. The flange 404 illustrated herein includes four openings 406. The openings 406 are embodied as through holes. The openings 406 are configured to receive mechanical fasteners (not shown) in order to couple the first member 402 with the underframe 102. The first member 402 includes a projection 408 extending from a lower surface of the flange 404. The projection 408 is approximately V-shaped (see FIG. 4). The first member 402 includes a lower surface 412 that is defined at a lower end 414 of the projection 408.

Referring to FIG. 3, the mount assembly 400 includes a second member 416. The second member 416 is configured to be coupled to the cab 104. As shown in FIG. 4, the second member 416 is partially received within the hollow portion of the first member 402 (see FIG. 4). The second member 416 includes a first portion 418. The first portion 418 is substantially wedge shaped. Further, the first portion 418 has a tapered cross-section (see FIG. 4). A portion of the first portion 418 projects outwards from the first member 402. An upper surface 420 of the first portion 418 includes a number of openings 422. In one example, the upper surface 420 includes four openings 422. The openings 422 are embodied as blind holes. The openings 422 are configured to receive mechanical fasteners (not shown) in order to couple the second member 416 with the cab 104.

Referring to FIG. 4, the second member 416 includes an extension 424. The extension 424 projects from a lower end of the first portion 418. The extension 424 has a rectangular cross-section. In one example, a length of the extension 424 is comparatively greater than the first portion 418 of the second member 416. A portion of the extension 424 is received within the hollow portion of the first member 402. The extension 424 includes a first surface 426 and a second surface 428. The second surface 428 is provided opposite to the first surface 426. The first and second surfaces 426, 428 of the extension 424 are horizontally spaced apart from the lower surface 412 of the first member 402. A distance “D” is defined (see FIG. 4) between the lower surface 412 of the first member 402 and each of the first and second surfaces 426, 428 respectively.

Referring to FIGS. 3 and 4, the mount assembly 400 includes at least one isolation member. The mount assembly 400 disclosed herein includes a pair of isolation members 430, 432. A portion of the isolation members 430, 432 projects outwards from the first member 402 (see FIG. 3). As shown in FIG. 4, a substantial portion of the isolation members 430, 432 are provided within the hollow portion of the first member 402. More particularly, the isolation members 430, 432 are provided between the first member 402 and the second member 416, such that the isolation members 430, 432 are tightly held therebetween. The isolation members 430, 432 are arranged in a V-configuration. The isolation members 430, 432 may be made of a rubber, or any other material that provides isolation properties.

Due to significant loads experienced by the cab 104, there is a possibility of the second member 416 being separated and disconnected from the rest of the mount assembly 400. The mount assembly 400 therefore includes at least one snubber member. The mount assembly 400 disclosed herein includes a pair of snubber members, namely a first snubber member 434 and a second snubber member 436. The first and second snubber members 434, 436 are configured to restrict the disconnection of the second member 416 from the mount assembly 400. The first and second snubber members 434, 436 are vertically spaced apart from the lower surface 412 of the first member 402.

The first and second snubber members 434, 436 have a rectangular cross section. However, the cross section of the snubber members 434, 436 may vary without limiting the scope of the present disclosure. Further, each of the first and second snubber members 434, 436 are substantially square in shape. Alternatively, the snubber members 434, 436 may have a different shape. For example, the snubber members 434, 436 may be rectangular shaped, circular shape, trapezoidal shape, and the like. The first and second snubber members 434, 436 are coupled to the extension 424 of the second member 416. Each of the first and second snubber members 434, 436 are horizontally spaced apart from each other. The first snubber member 434 is coupled to the first surface 426, whereas the second snubber member 436 is coupled to the second surface 428 of the extension 424.

Referring to FIG. 3, a length “L1” of the first snubber member 434 and the length (not shown) of the second snubber members 436 is equal to a width “W” of each of the first and second surfaces 426, 428 of the extension 424. In an alternate example, the length “L1”, “L2” of each of the first and second snubber members 434, 436 may be greater than the width “W” of each of the first surface 426 and the second surface 428.

Referring now to FIG. 4, each of the first and second snubber members 434, 436 include a thickness “T1”, “T2” respectively. The thickness “T1”, “T2” is decided such that the thickness “T1”, “T2” of each of first and second snubber members 434, 436 is greater than the distance “D”. In one example, the thickness “T1”, “T2” of each of first and second snubber members 434, 436 may be lesser than the distance “D”. In such an example, the length “L1”, “L2” of the snubber members 434, 436 are greater than the width “W”.

The first and second snubber members 434, 436 may be coupled at any location along the length of the extension 424. Referring to FIGS. 3 and 4, the first and second snubber members 434, 436 include openings (not shown). In one example, each of the first and second snubber members 434, 436 include four openings. The openings are embodied as through holes. The openings on each of the first and second snubber members 434, 436 are configured to be aligned with corresponding openings (not shown) provided on the first and second surfaces 426, 428 to receive mechanical fasteners 438, 440. The mechanical fasteners 438, 440 are configured to mount each of the first and second snubber members 434, 436 to the first and second surfaces 426, 428 of the extension 424 respectively. In the illustrated embodiment, four mechanical fasteners 438, 440 are used to couple the respective first and second snubber members 434, 436 to the extension 424; however the number of mechanical fasteners 438, 440 may vary based on the required connection strength. The mechanical fasteners 438, 440 may embody any one of a bolt, screw, rivet, pin, and the like.

Alternatively, the first and second snubber members 434, 436 may be coupled to the respective first and second surfaces 426, 428 of the extension 424 using a different joining process. For example, the snubber members 434, 436 may be welded to the respective first and second surfaces 426, 428 of the extension 424. In another example, the snubber members 434, 436 may be bonded with the respective first and second surfaces 426, 428 using an adhesive.

In yet another example, the snubber members 434, 436 may be integral with the extension 424 of the second member 416. In such examples, the distance “D” (see FIG. 4) may be greater than the thickness “T1”, “T2” of the first and second snubber members 434, 436 respectively, to allow vertical insertion of the second member 416 in the hollow portion of the projection 408. Further, after the insertion of the second member 416, the distance “D” may be controlled by introduction of a closure plate. In another example, one side of the projection 408 may be removed to allow horizontal insertion of the second member 416 in the hollow portion of the projection 408. After assembly of the mount assembly 400, the side of the projection 408 may be sealed using a closure plate.

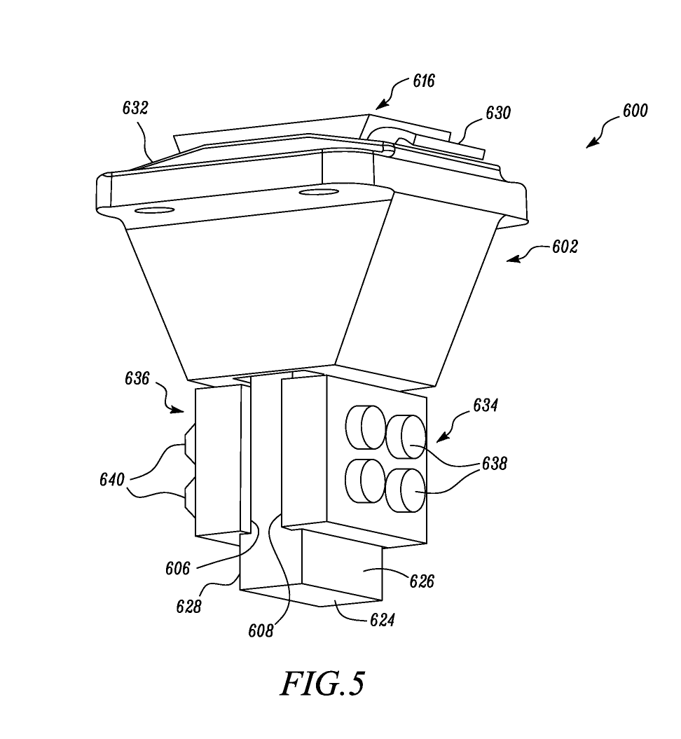

FIG. 5 illustrates an alternate design of the mount assembly 600. The design of the first member 602 and the isolation members 630 of the mount assembly 600 is similar to the design of the first member 402 and the isolation members 430 of the mount assembly 400 described in relation to FIGS. 3 and 4. The mount assembly 600 shown in the accompanying figures additionally includes a pair of steps, namely a first step 606 and a second step 608. The first and second steps 606, 608 are provided on the second member 616. More particularly, the first and second steps 606, 608 are provided on the first and second surface 626, 628 of the extension 624 respectively. Each of the first and second steps 606, 608 is configured to receive and capture a corresponding first and second snubber member 634, 636 thereon. The first and second snubber members 634, 636 are coupled to the first and second surfaces 626, 628 of the extension 624 using mechanical fasteners 638, 640 in a manner similar to that explained with respect to the mount assembly 400 shown in FIGS. 3 and 4.

### INDUSTRIAL APPLICABILITY

The design of the mount assembly 400, 600 disclosed herein provides a reliable and higher strength connection between the snubber members 434, 436, 634, 636 and the rest of the mount assembly 400, 600. The extension 424, 624 of the mount assembly 400, 600 allows the pair of snubber members 434, 436, 634, 636 to be fixed to the respective extension 424, 624 with a number of mechanical fasteners 438, 440, 638, 640. Further, as per strength requirements, the design of the mount assembly 400, 600 allows the number of mechanical fasteners 438, 440, 638, 640 to be increased without any limitations.

The increased connection strength between the snubber members 434, 436, 634, 636 and the extension 424, 624 reduces the possibility of the second member 416, 616 to separate from the mount assembly 400, 600, thereby restricting the disconnection of the cab 104 from the underframe 102. Further, the mount assembly 600 includes the pair of steps 606, 608 provided on the extension 424, 624. Hence, the strength of the mount assembly 600 is no longer dependent on the shear strength of the mechanical fasteners 638, 640 as the pair of steps 606, 608 forms a mechanical locking connection.

The mount assembly 400, 600 disclosed herein provides isolation of the machine structure from vibrating and noise producing components of the machine. Further, the mount assembly 400, 600 also provides isolation of vibration sensitive components of the machine 100, thereby preventing damage of the vibration sensitive components due to shock and vibration.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mount assembly for a machine having a cab mounted on an underframe, the mount assembly comprising:
a first member coupled to the underframe;
a second member coupled to the cab and at least partly received within the first member, the second member comprising an extension projecting from the first member;
an isolation member disposed between the first member and the second member; and
a pair of snubber members coupled to the extension of the second member, each of the pair of snubber member being spaced apart from the first member.

2. The mount assembly of claim 1, wherein the extension comprises a first surface and a second surface opposite to the first surface, wherein one of the pair of snubber members are coupled to the first surface, and wherein another of the pair of snubber members are coupled to the second surface.

3. The mount assembly of claim 2, wherein a length of each of the pair of snubber members is greater than or equal to a width of each of the first surface and the second surface.

4. The mount assembly of claim 1 further comprising a plurality of fasteners configured to mount each of the pair of snubber member to the extension.

5. The mount assembly of claim 1, wherein the extension defines a pair of steps, wherein each of the pair of steps is configured to receive a corresponding snubber member of the pair of snubber members thereon.

6. The mount assembly of claim 1, wherein the extension has a rectangular cross-section.

7. The mount assembly of claim 1, wherein each of the pair of snubber members has a rectangular cross-section.

8. The mount assembly of claim 1 further comprising a pair of isolation members disposed between the first member and the second member.

9. The mount assembly of claim 1, wherein the first member comprises a lower surface spaced apart from the extension, and wherein a thickness of each of the pair of snubber members is greater than a distance between the lower surface and the extension.

10. A locomotive comprising:
an underframe;
a cab mounted on the underframe; and
a mount assembly disposed between the cab and the underframe, the mount assembly comprising:
a first member coupled to the underframe;
a second member coupled to the cab and at least partly received within the first member, the second member comprising an extension projecting from the first member;
an isolation member disposed between the first member and the second member; and
at least one snubber member coupled to the extension of the second member, each of the pair of snubber member being spaced apart from the first member.

11. The locomotive of claim 10, wherein the extension comprises a first surface and a second surface opposite to the first surface, wherein one of the pair of snubber members are coupled to the first surface, and wherein another of the pair of snubber member are coupled to the second surface.

12. The locomotive of claim 11, wherein a length of each of the pair of snubber members is greater than or equal to a width of each of the first surface and the second surface.

13. The locomotive of claim 10 further comprising a plurality of fasteners configured to mount each of the pair of snubber member to the extension.

14. The locomotive of claim 10, wherein the extension defines a pair of steps, wherein each of the pair of steps is configured to receive a corresponding snubber member of the pair of snubber members thereon.

15. The locomotive of claim 10, wherein the extension has a rectangular cross-section.

16. The locomotive of claim 10, wherein each of the pair of snubber members has a rectangular cross-section.

17. The locomotive of claim 10 further comprising a pair of isolation members disposed between the first member and the second member.

18. The locomotive of claim 10, wherein the first member comprises a lower surface spaced apart from the extension, and wherein a thickness of each of the pair of snubber members is greater than a distance between the lower surface and the extension.

19. A mount assembly for a machine having a cab mounted on an underframe, the mount assembly comprising:
a first member coupled to the underframe, the first member comprising a lower surface;
a second member coupled to the cab and at least partly received within the first member, the second member comprising an extension projecting from the first member, wherein the extension comprises a first surface and a second surface opposite to the first surface, and wherein each of the first surface and the second surface is spaced apart from the lower surface of the first member;
a pair of isolation members disposed between the first member and the second member; and
a pair of snubber members coupled to the extension of the second member, each of the pair of snubber member being spaced apart from the lower surface of the first member, wherein one of the pair of snubber members are coupled to the first surface, wherein another of the pair of snubber members are coupled to the second surface, and wherein a thickness of each of the pair of snubber members is greater than a distance between each of the first surface and the second surface of the extension and the lower surface of the first member.

20. The mount assembly of claim 19, wherein each of the first surface and the second surface defines a step configured to receive a corresponding snubber member of the pair of snubber members thereon.
